(19) United States
(12) Patent Application Publication
(10) Pub. No.: US 2024/0220678 A1
(43) Pub. Date: Jul. 4, 2024

(54) ESTIMATING ELECTRICITY POTENTIAL FROM SUBSURFACE GEOTHERMAL RESERVOIRS

(71) Applicant: SAUDI ARABIAN OIL COMPANY, Dhahran (SA)

(72) Inventors: Bryan HALL-THOMPSON, Dhahran (SA); Ahmed H. HUTHELI, Dhahran (SA); Mohammad R. HUDAITHI, Dhahran (SA); Ghadeer A. ALRUMAIH, Dhahran (SA)

(73) Assignee: SAUDI ARABIAN OIL COMPANY, Dhahran (SA)

(21) Appl. No.: 18/295,475

(22) Filed: Apr. 4, 2023

Related U.S. Application Data
(60) Provisional application No. 63/478,062, filed on Dec. 30, 2022.

(51) Int. Cl. G06F 30/20

(52) U.S. Cl. CPC G06F 30/20; G06F 2111/08

(57) ABSTRACT

The present disclosure is related to systems and/or computer-implemented methods that can estimate an amount of electrical power that can be generated from a geothermal subsurface reservoir. One or more embodiments described herein can include a system, which can comprise a memory to store computer executable instructions. The system can also comprise one or more processors, operatively coupled to the memory, which can execute the computer executable instructions to implement a stochastic model configured to execute a Monte Carlo algorithm that quantifies uncertainty associated with parameters characterizing a geothermal subsurface reservoir. The stochastic model can be further configured to estimate an amount of electrical power associated with the geothermal subsurface reservoir based on the parameters. Additionally, the computer executable instructions can comprise an economic analyzer that generates determines an of hydrocarbon fuel required to produce the amount of electrical power.

### FIELD OF THE DISCLOSURE

The present disclosure relates generally to systems and/or methods for estimating the amount of electrical power that can be generated from a subsurface geothermal reservoir and, more particularly, to systems and/or methods that can incorporate reservoir simulators, observed production performance metrics, and/or analytical models to estimate electrical power generation and/or rare earth element (“REE”) such as lithium, boron, phosphates or similar minerals extraction as part of an economic analysis of the subsurface geothermal reservoir.

### BACKGROUND OF THE DISCLOSURE

With increasing requirements for low emission energy sources and a desire to reduce energy generation from fossil fuel sources, geothermal heat energy is a growing sector within the global energy transition plan that contributes to various applications such as: electricity generation, heating applications, desalination, and/or cooling operations. The growth in geothermal energy is achieved due to the renewable nature of the energy source, which can be sustainable as a base load energy source independent of weather or storage requirements, and the flexibility to utilize the heat sources at a domestic and/or industrial scale.

Geothermal energy is classified as: (1) high enthalpy heat sources produced from convective hydrothermal sources or natural sedimentary hot aquifers; or (2) low enthalpy geothermal systems produced from existing oilfield reservoirs or aquifers post stimulation called enhanced geothermal systems. Depending on originating temperature, geothermal energy can be utilized for electricity generation, heating/cooling applications, agricultural food processing, and water desalination. High enthalpy geothermal energy can be utilized for electricity generation through heat engines and processes that convert heat to electricity such as dry natural steam power plants, flash steam power plants, or binary cycle power plants that utilize a second fluid to support steam generation for subsequent electricity generation. Low enthalpy geothermal and also high heat enthalpy are commonly utilized as a heating source for both industrial, agricultural and domestic use. In other applications, geothermal energy is typically used for district cooling applications, water desalination and natural gas processing applications such as LNG regasification and sour water treatment.

Specific to the oil industry, energy obtained from geothermal energy sources can directly displace valuable hydrocarbon products that can be sold at preferred prices. For this reason, it is now common practice for oil companies to utilize existing oil and gas wells, or drill and stimulate new wells, as part of the enhanced geothermal system. To effectively manage the profitability and sustainability of this process, reservoir simulation models that include geological details, or as a minimum volumetric information of fluids in place, are required to estimate the potential heat energy that can be derived from subsurface reservoirs. Using the results from the simulation models, external assessment is still required to accurately predict the quantity of geothermal electricity that can be obtained from any selected electricity generation process.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system is provided. The system can comprise memory to store computer executable instructions. The system can comprise one or more processors, operatively coupled to the memory, that execute the computer executable instructions to implement a stochastic model configured to execute a Monte Carlo algorithm that quantifies uncertainty associated with parameters characterizing a geothermal subsurface reservoir via a plurality of probability distributions. The one or more processors can also execute the computer executable instructions to implement an economic analyzer configured to estimate an amount of electrical energy associated with the geothermal subsurface reservoir based on the stochastic model.

In another embodiment, a computer-implemented method is provided. The computer-implemented method can comprise executing a Monte Carlo algorithm that quantifies uncertainty associated with parameters characterizing a geothermal subsurface reservoir to generate a stochastic model of the parameters that includes a plurality of probability distributions. The computer-implemented method can also comprise estimating an amount of electrical energy associated with the geothermal subsurface reservoir based on the stochastic model.

In a further embodiment, a computer program product for predicting electrical energy production associated with a geothermal subsurface reservoir is disclosed. The computer program product includes a computer readable storage medium having computer executable instructions embodied therewith. The computer executable instructions executable by one or more processors cause the one or more processors to execute a Monte Carlo algorithm that quantifies uncertainty associated with parameters characterizing the geothermal subsurface reservoir to generate a stochastic model of the parameters that includes a plurality of probability distributions. The computer executable instructions can also cause the one or more processors to estimate an amount of electrical energy associated with the geothermal subsurface reservoir based on the stochastic model.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is diagram of a non-limiting example system that can estimate electrical power generation associated with a geothermal subsurface reservoir based on stochastic modeling of reservoir parameters derived from a reservoir simulator, user defined inputs, and/or an analytic mass and heat model in accordance with one or more embodiments described herein.

FIG. 2 is diagram of a non-limiting example system that can estimate electrical power generation associated with a geothermal subsurface reservoir based on stochastic modeling of reservoir parameters derived from a reservoir simulator coupled to an enhanced geothermal system in accordance with one or more embodiments described herein.

FIG. 3 is a flow diagram of a non-limiting example computer-implemented method that can be implemented by a system to estimate electrical power generation associated with a geothermal subsurface reservoir based on stochastic modeling of reservoir parameters derived from or as inputs to a reservoir simulator coupled to an enhanced geothermal system in accordance with one or more embodiments described herein.

FIG. 4 is a diagram of a non-limiting example system that can estimate electrical power generation associated with a geothermal subsurface reservoir via a standalone computer application that stochastically models user defined parameters characterizing the reservoir in accordance with one or more embodiments described herein.

FIG. 5 is a flow diagram of a non-limiting example computer-implemented method that can be implemented by a system to perform one or more economic analyses regarding a geothermal subsurface reservoir based on an electrical power generation estimate in accordance with one or more embodiments described herein.

FIG. 6 illustrates a block diagram of non-limiting example computer environment that can be implemented within one or more systems described herein.

### DETAILED DESCRIPTION

Embodiments of the present disclosure will now be described in detail with reference to the accompanying figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Typically, subsurface reservoir models isothermally predict hydrocarbon or water mass and volume flow rates in isolation (e.g., where flow rates are predicted at a constant temperature). Estimates of thermal power, electrical power, and/or extracted economic mineral components (e.g., REE, such as lithium) from subsurface energy sources are computed externally, independent of the subsurface model system. For example, typical isothermal analytical and numerical models predict only the mass or fluid flow of petroleum fluids and are limited to the prediction of volumes for petroleum or subsurface water production applications. Even complex compositional simulators merely model complexities associated with multi-component fluids and require additional model plug-ins to account for thermal injection or production changes. Additionally, due to uncertainty associated with reservoir models and produced heat, variations can exist in electricity and power generation estimates.

Embodiments in accordance with the present disclosure generally relate to systems and/or computer-implemented methods that can estimate an amount of electrical power and/or energy associated with a subsurface geological, geothermal, and/or hydrocarbon reservoir. Various embodiments described herein can predict thermal, electrical, and/or chemical potential from subsurface reservoir models, such as subsurface hydrocarbon reservoir models and/or geothermal quality reservoir models. For example, one or more systems and/or computer-implemented methods described herein can estimate heat in place quantities, electricity power generation potential, and/or REE extraction potential directly from one or more reservoir models, which can be scaled for regional geothermal and/or electricity assessments. Further, the systems and/or computer-implemented methods described herein can directly predict electrical power generation from geothermal reservoirs based on non-isothermal modeling. Additionally, the systems and/or computer-implemented method described herein can estimate an amount of REEs that can be extracted from water sources in the reservoir system. One or more embodiments can utilize aerial, thermal, rock, and/or flow characteristics of identified subsurface reservoirs to: estimate the total heat energy resource in place, compute the estimated heat quantities that can be produced, and/or convert the heat quantities to estimated electricity quantities for industrial and/or domestic use.

For example, various embodiments described herein can independently estimate thermal and/or electrical power potential from subsurface reservoir information (e.g., porosity, rock composition, water composition, reservoir area, a combination thereof, and/or the like). For instance, independent or external subsurface reservoir models can be utilized to estimate thermal power potential, which can be integrated with one or more surface electricity generation workflows to convert estimated thermal power to electrical power estimates. Additionally, an estimate of the hydrocarbon resource opportunity cost in relation to geothermal electricity can be determined along with a determination of equivalent carbon dioxide emission reductions.

Due to the uncertainty associated with subsurface estimations, one or more embodiments described herein can employ a direct stochastic prediction using a plurality of estimation parameters (e.g. about fifteen or more respective parameters) with potential distribution patterns. Stochastic estimation of multiple inputs analyzed by the systems and/or computer-implemented method described herein can benefit the user in economic planning and uncertainty management for geothermal opportunities. Additionally, deterministic estimates for thermal and electrical power can also be obtained.

Thereby, various embodiments described herein can constitute one or more technical improvements over conventional subsurface models by enabling a prediction of the quantity of electricity that may be produced based on geothermal conditions characterized by a subsurface reservoir simulation and/or an analytical model. For instance, various embodiments described herein can integrate one or more uncertainty calculation options and economic modeling workflows with reservoir numerical and/or analytical models for the analysis and/or prediction of grid electricity.

Additionally, one or more embodiments described herein can have a practical application by performing independent stochastic thermal power estimations, electrical power estimations, and mineral content estimations using reservoir models (e.g., numerical models and/or material balance models) and given rock properties with minimal geological, logging, or seismic information. Moreover, the systems and methods described herein can estimate a hydrocarbon equivalent or hydrocarbon opportunity cost. For example, one or more embodiments described herein can stochastically estimate an amount of carbon dioxide equivalent emissions avoided by utilizing geothermal electricity in place of hydrocarbon fueled electricity generation. Further, various embodiments described herein can integrate financial and stochastic modelling of revenue and/or costs for produced electricity and/or extracted mineral resources.

Advantageously, the electricity predictions described herein can be derived directly from subsurface reservoir simulations, observed production outputs associated with the subsurface reservoir, and/or defined subsurface reservoir parameters. For instance, one or more embodiments can incorporate workflows for electricity generation predictions and/or preliminary assessments of electricity development projects into pre-defined subsurface reservoir models, which can include: reservoir heat computations, reservoir production predictions, surface heat rate predictions, heat rate to electrical energy conversions, quantification of associated minerals and emission, and/or economic and stochastic computations.

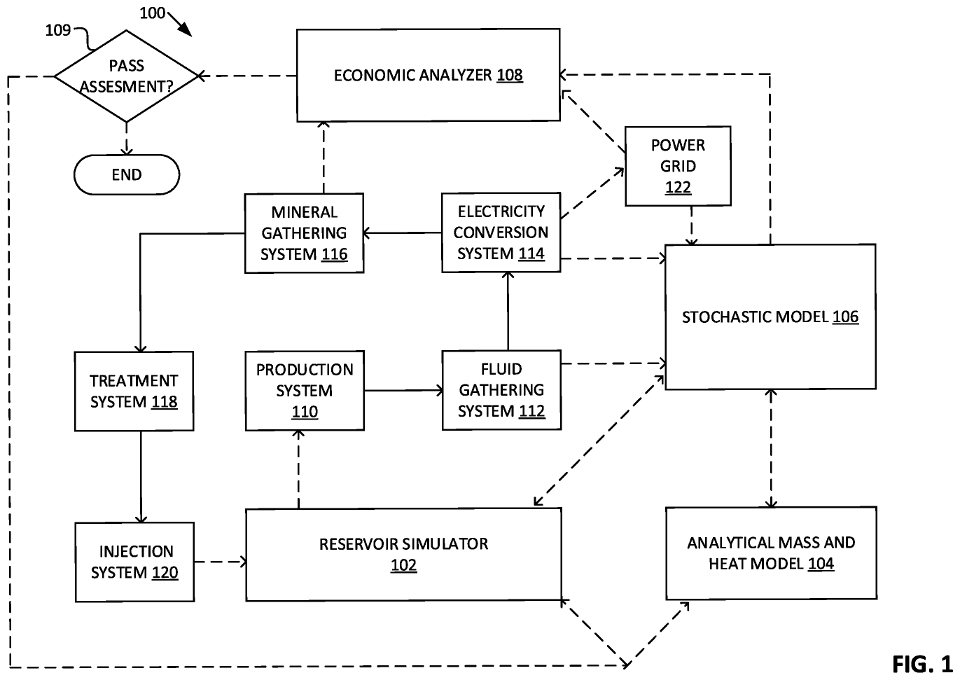

FIG. 1 depicts a non-limiting example system 100 that can be configured to estimate an amount of electrical power that can be produced from a subsurface geothermal reservoir (e.g., a high enthalpy or low enthalpy geothermal source) based on one or more reservoir simulators 102 and/or analytical mass and heat models 104 that can utilize inline equations and efficiency factors for various thermal to electrical conversions. As shown in FIG. 1, solid lines can delineate pipe circuitry (e.g., comprising pipes, pumps, meters, valves, controllers, wells, and/or the like), where the direction of the arrow can indicate the direction of flow of one or more fluids housed within the pipe circuitry. Additionally, dashed lines can delineate electrical connections, where components coupled by dashed lines can be operably coupled and the arrow can indicate the direction of data communications in accordance with one or more workflows described herein.

The system 100 can be configured to estimate a split between direct geothermal energy and thermal energy equivalents from hydrocarbon sources. The system 100 can address uncertainty and/or risk management associated with modeled parameters by implementing stochastic simulation options via a stochastic model 106. For example, the system 100 can employ the stochastic model 106 to generate stochastic input parameter distributions and output estimation distributions that quantify uncertainties associated with geothermal energy production and/or electricity production from the subsurface reservoirs. Additionally, the system 100 can utilize an economic analyzer 108 to compute various economic analyses, such as energy equivalences to user requirements and/or estimations of negated carbon emissions.

In one or more embodiments, the electrical power generation predictions and/or economic predictions generated by the economic analyzer 108 can further be assessed at step 109. For example, the values defining the electrical power generation predictions and/or economic predictions can be compared to one or more predefined thresholds to ascertain whether the modelled conditions are predicted to achieve desired performance metrics. Where the electrical power generation predictions and/or economic predictions pass the assessment (e.g., meet the predefined thresholds), the system 100 workflow can end. Where the electrical power generation predictions and/or economic predictions fail the assessment (e.g., fail to meet the predefined thresholds), the system 100 workflow can return the results to the one or more reservoir simulators 102 and/or analytical mass and heat models 104 to explore the impact of altering one or more production parameters and/or probability distributions.

In various embodiments, electrical power predictions and economic analyses described herein can be based on inputs provided by the one or more reservoir simulators 102. For example, the one or more reservoir simulators 102 can characterize a given subsurface reservoir via one or more modeled parameters. Further, the stochastic model 106 can generate distributions for the modeled parameters that quantify uncertainty associated with the stochastic nature of the reservoir's properties. The parameter distributions can then be analyzed by the economic analyzer 108 to perform various electrical power estimations and/or economic analyses described herein. Additionally, the reservoir simulator 102 and/or the stochastic model 106 can be coupled to an enhanced geothermal system comprising a production system 110, fluid gathering system 112, electricity conversion system 114, mineral gathering system 116, treatment system 118, and/or injection system 120. For instance, measured flow rates and/or electricity production can be analyzed by the stochastic model 106. In another instance, the electricity conversion system 114 can supply electricity to a power grid 122, which can be operably coupled with the stochastic model 106 and/or the economic analyzer 108 to provide electricity rates and/or facilitate net electricity computations in accordance with one or more embodiments described herein.

The economic analyzer 108 can convert hydrocarbon and/or water mass rates into thermal power estimates and further into electrical power estimates in accordance with various embodiments described herein. The amount of energy (e.g., in kilowatts) or the amount of power (e.g., in kilowatts per hour) can be directly derived from the subsurface model generated by the reservoir simulators 102. Additionally, the economic analyzer 108 can estimate an amount of mineral extraction (e.g., lithium oxide or lithium carbonate equivalents) based on the reservoir simulator 102 models. Where the system 100 is coupled to an enhanced geothermal system (e.g., as shown in FIG. 1), mineral resource extraction predictions can be further based on a water chemistry analysis performed by the mineral gathering system 116 along with volumes or flow rates measured by the fluid gathering system 112 in accordance with various embodiments described herein.

In some embodiments, the electrical power predictions and economic analyses described herein can be based on user defined input parameters used to initialize the one or more analytical mass and heat models 104. For example, a user of the system 100 can define one or more inputs characterizing a given subsurface reservoir, where the inputs can be stochastically modeled by the stochastic model 106 and utilized by the analytical mass and heat model 104 to predict fluid mass rates, which can then be used to predict thermal and/or electrical power generation. Additionally, the thermal and/or electrical power predictions can be stochastically modeled by the stochastic model 106 and analyzed by the economic analyzer 108 to perform various electrical power estimations and/or economic analyses described herein.

The one or more reservoir simulators 102 can be one or more computer programs used to model and predict the behavior of fluids (e.g., water, hydrocarbons, oil, natural gas, and/or the like) within a subsurface reservoir. For example, the one or more reservoir simulators 102 can be employed by the system 100 to predict the flow of fluids within the reservoir and/or the response of the reservoir to different production scenarios. The reservoir simulators 102 can utilize mathematical and/or computational models to simulate the physical processes that occur within a given subsurface reservoir (e.g., including fluid flow, heat transfer, rock properties, fluid properties, a combination thereof, and/or the like). For example, the reservoir simulators 102 can incorporate data on the geology, geochemistry, and/or petrophysics of the subsurface reservoir. In another example, the reservoir simulators 102 can further incorporate data characterizing operations of components of the production system 110, such as wellbores and production equipment, used to extract fluid from the subsurface reservoir. Outputs of the one or more reservoir simulators 102 can be used to optimize the design and/or operation of the production system 110 in view of an energy and/or economic analysis provided by the economic analyzer 108. Additionally, the system 100 can utilize the reservoir simulators 102 to predict long-term performance associated with the given subsurface reservoir, including production over time, the impact of production strategy variations, and/or changes in reservoir properties (e.g., such as temperature).

In one or more embodiments, the one or more reservoir simulators 102 can be configured to output production rates as a function of mass, such as: kilograms per second (kg/sec), tonne per hour (Tonne/hr), and/or the like. For instance, the one or more reservoir simulators 102 can determine production rates in volumes and convert such volumes into representative mass rates using densities of the produced fluids at the defined operating pressure and temperature. In one or more embodiments, the flowing well head temperature of the produced fluid is used with the defined ambient conditions and heat capacity (e.g., user defined) of the producing fluid to initiate a first estimate of thermal energy available from the subsurface reservoir. Further, the one or more reservoir simulators 102 can include features to specify reservoir temperatures and variations in temperature along depth of the subsurface reservoir. In one or more embodiments, the one or more reservoir simulators 102 can be configured for user defined operating wellhead pressure, facilities pressure, and/or reservoir pressure. As an output, the one or more reservoir simulators 102 can predict pressures across the production system 110. For example, the outflow pressure can be used to determine the requirement for artificial lift, such as electrical submersible pumps. As part of deriving the final electricity produced from the one or more reservoir simulators 102, the power consumed by the electrical submersible pump is subtracted from the total electricity computed in this system 100.

The one or more analytical mass and heat models 104 can be one or more mathematical models that characterize the flow of fluids (e.g., oil and/or water) and transfer of heat within a subsurface reservoir. For example, the analytical mass and heat models 104 can estimate the mass and/or associated heat of fluids contained within the subsurface reservoir based on principles of mass and energy conservation, where fluid flow and heat transfer can be described using analytical solutions to governing equations, as described further herein. For instance, the system 100 can utilize the analytical mass and heat models 104 to predict temperature distributions within a given subsurface reservoir and/or the impact of heat transfer on the production of fluids (e.g., on the production of hydrocarbons). When using the one or more analytical mass and heat models 104, the system 100 can consider the reservoir porosity, fluid recovery factor, range of reservoir temperature, presence of aquifer or large water body supporting pressure maintenance, density of the given rock type, thickness of geothermal reservoir and similar water bearing body and the water quality that is an indication of perceived chemistry and contamination risks. As outputs the reservoir will output fluid compositions and especially presence of any impurities such as CO₂ and H₂S that impacts the safety and support the assessment of the emission impacts from exploitation of geothermal energy from such reservoirs.

The one or more stochastic models 106 can be computational models used by the system 100 to quantify the uncertainty and/or variability associated with models (e.g., generated by the one or more reservoir simulators 102 and/or analytical mass and heat models 104) characterizing the subsurface reservoir. In various embodiments, the one or more stochastic models 106 can execute a Monte Carlo algorithm to quantify the uncertainty based on the Monte Carlo methodology, which involves the use of random sampling and statistical analysis to estimate the probability of different outcomes. For example, the system 100 can utilize the stochastic models 106 to analyze the uncertainty and/or variability of various parameters (e.g., geological, petrophysical, and/or fluid properties) of models characterizing the subsurface reservoir. By executing the Monte Carlo algorithm, the one or more stochastic models 106 can generate a large number of possible realizations of the reservoir via probability distributions of the input parameters, and then simulate the behavior of the reservoir under each realization; thereby enabling the one or more stochastic models 106 to estimate the range of possible outcomes and the likelihood of different outcomes occurring. Table 1, presented below, includes example Monte Carlo simulation (“MCS”) parameters that can be considered by the one or more stochastic models 106 in accordance with one or more embodiments described herein.

TABLE 1

| | | Example of | | | | | | | |
|---|---|---|---|---|---|---|---|---|---|
| Geothermal and Electricity | | MCS | | | | | | | |
| Parameters | Units | Distribution | MCS | Minimum | Likely | Maximum | Alpha | Beta | STD |
| Porosity | % | Beta | Y | Y | | Y | Y | Y | |
| Recovery Factor | fraction | Uniform | Y | Y | | Y | | | |
| Conversion Efficiency | fraction | Triangular | Y | Y | Y | Y | | | |
| Production Life | years | Fixed | Y | | | | | | |
| Load Factor | % | Triangular | Y | Y | Y | Y | | | |
| Areal Utilization | % | Beta | Y | Y | | Y | | | |
| Generator Efficiency | % | Triangular | Y | Y | Y | Y | | | |
| Reference Surface Temperature | C. °/F. | Triangular | Y | Y | Y | Y | | | |
| Low Enthalpy Temperature | C. °/F. | Beta | Y | Y | | Y | | | |
| Mid Enthalpy Temperature | C. °/F. | Beta | Y | Y | | Y | | | |
| High Enthalpy Temperature | C. °/F. | Beta | Y | Y | | Y | | | |
| Aquifer/Reservoir EGS only | Y/N | Beta | Y | | | | | | |
| Rock and Water Quality | % | Triangular | Y | Y | | Y | | | |
| Geological Success | % | Discrete | Y | Y | Y | Y | | | |
| Reservoir Thickness | (m, ft) | Normal | Y | | Y | Y | | | Y |

Examples of some Monte Carlo Simulation (MCS) Parameters relevant to project

In various embodiments, the system 100 can be implemented via one or more standalone computer applications or can be coupled to existing field models. For example, the reservoir simulator 102, the analytical mass and heat model 104, the stochastic model 106 and/or the economic analyzer 108 can be incorporated into a computer application (e.g., a web-based application) for assessing geothermal opportunities. For instance, a user of the system 100 can initially conduct a subsurface and/or surface assessment for geothermal potential (e.g., in terms of heat extent and chemical properties of rock types) to achieve geothermal extraction for industrial and/or domestic purposes. Types of assessments can include aerial imaging of rock types and/or surface temperatures, chemistry sample collections, magnetic imaging, physical temperature measurements, and/or the like. Additionally, the user can validate the measured conditions for feasibility of geothermal potential, which can include: a thermal gradient analysis for suitability in various thermal power applications, aquifer strength performance, field water production as mass rates, field depletion rates, field heat transfer coefficients, and/or the like. In one or more embodiments, geothermal potential can be determined from methods that can include, but are not limited to: areal/satellite imaging of rock types and surface temperature measurements, geothermometry, radioactive logs, hydrochemistry, subsurface chemistry sample collection, magnetic imaging, aquifer pressure measurements, rock resistivity, neutron and density measurements, a combination thereof, and/or the like.

In one or more embodiments, a user can enter the assessment information into the system 100 and utilize the computer application to analyze the geothermal opportunity via a variety of options. In a first option, the user can utilize the assessment information to initialize the one or more reservoir simulators 102 to model the subsurface reservoir. Further, in some embodiments, the reservoir simulators 102 can be coupled to one or more production systems 110, which can be optimized based on the stochastic modelling and/or economic analyses described herein. In a second option, the user can utilize the assessment information to initialize the one or more analytical mass and heat models 104 to model the subsurface reservoir. In a third option, the user can further utilize the one or more stochastic models 106 and/or economic analyzer 108 to estimate electrical power generation and/or economic analyses (e.g., revenue projections, cost projections, mineral extraction predictions, carbon dioxide conservation predictions, and/or the like) based on parameters modeled by the one or more reservoir simulators 102 or analytical mass and heat models 104.

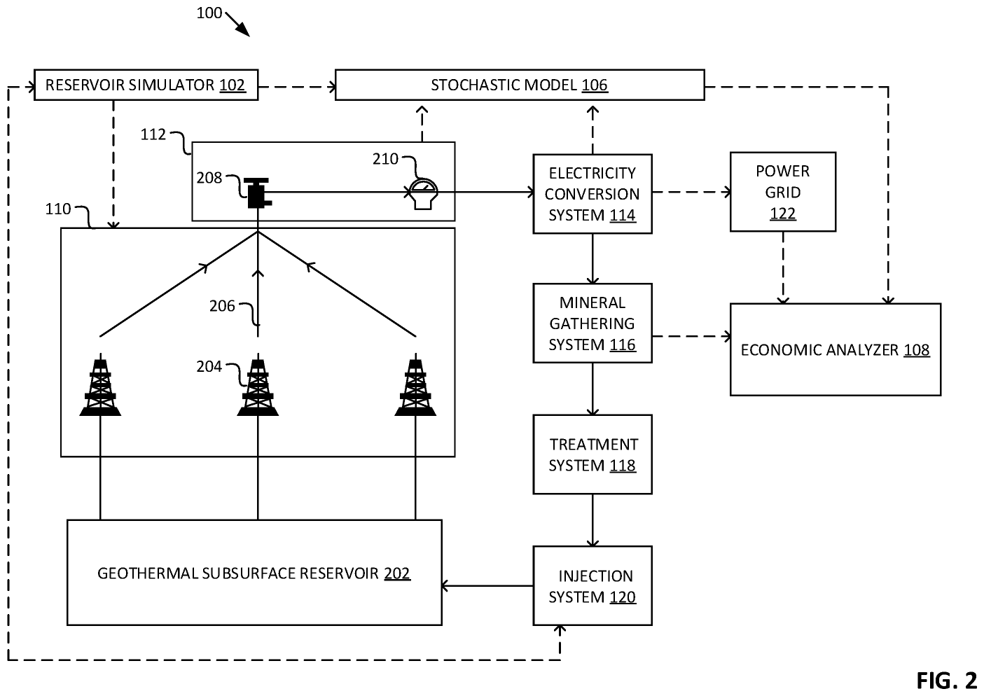

FIG. 2 illustrates an example embodiment in which the system 100 can estimate electricity generation and perform an economic analysis for a geothermal subsurface reservoir 202 (e.g., a high enthalpy or low enthalpy reservoir) based on one or more models generated by the reservoir simulator 102 and/or operation data collected from a coupled geothermal system in accordance with one or more embodiments described herein. As shown in FIG. 2, the production system 110 can comprise one or more wells 204 in fluid communication with the geothermal subsurface reservoir 202. The one or more wells 204 can be utilized to extract fluid (e.g., water and/or hydrocarbons) from the geothermal subsurface reservoir 202. Further, the production system 110 can comprise a network of pipes 206 configured to gather the fluid from the one or more wells 204.

Further, the production system 110 can supply the extracted fluid to the fluid gathering system 112. In one or more embodiments, the fluid gathering system 112 can comprise one or more pumps 208 and/or meters 210. As shown in FIG. 2, the fluid gathering system 112 can be operably coupled to the one or more stochastic models 106. For example, the fluid gathering system 112 can provide the stochastic model 106 with one or more input parameters, such as fluid flow rates and/or volume measured by the one or more meters 210.

The fluids gathered by the fluid gathering system 112 can be supplied to the one or more electricity conversion systems 114. In various embodiments, the electricity conversion system 114 can convert thermal energy captured from the Earth by the fluid into electricity. For example, the fluids can be used to drive one or more steam turbines to produce electricity. In various embodiments, the electrical conversion systems 114 can determine a power conversion factor to be applied within the system 100. For example, the one or more electricity conversion systems 114 can include one or more of the following systems for classification of geothermal to electrical conversions. (1) The one or more electricity conversion systems 114 can include a direct conversion system used in association with a vapor dominated system in high enthalpy geothermal systems, where steam is produced at surface and converted directly to electricity using steam turbines. (2) The one or more electricity conversion systems 114 can include a flash conversion system used for medium enthalpy geothermal systems, where the liquid is produced to surface and flashed to steam in a surface fluid separator and such steam is converted to electricity in steam turbines. (3) The one or more electricity conversion systems 114 can include a binary conversion systems in low enthalpy or EGS systems, where liquid is produced to surface but due to the low temperature the liquids are flowed through working fluid where the heat content is transferred to produce steam and electricity in a closed loop system. For each electricity conversion system, a conversion factor is determined through empirical assessment of thermal to electrical conversion ratio as obtained from an external database of existing projects.

Other electricity conversion systems 114 that can be implemented by the proposed system 100 include solid state thermoelectric generators that convert heat to electricity based on the differences in temperature between the two surfaces of the thermoelectric generator. Solid state thermoelectric generator systems do not use moving parts; however, they deliver electricity at a lower conversion rate that is accounted for in the proposed system 100. As shown in FIG. 2, the electricity conversion system 114 can be operably coupled to one or more power grids 122 (e.g., via one or more transformers, electrical lines, switches, meters, and/or the like). Additionally, the electricity conversion system 114 can provide the stochastic model 106 with one or more input parameters, such as: the amount of electricity supplied to the power grid 122 for a given time period, the efficiency of one or more electrical generators utilized by the electricity conversion system 114, and/or transmission loss experienced in delivering the electricity to the power grid 122.

The fluids can be supplied to the mineral gathering system 116, which can perform one or more geochemical analyses to detect mineral concentrations in the fluid supply. For example, the mineral gathering system 116 can detect characteristics of the fluid associated with the presence of REE, such a lithium oxide and/or lithium carbonate equivalent. Example analyses that can be performed by the mineral gathering system 116 can include, but are not limited to: estimation of lithium extraction potential given the concentration (mg/l, lb/gal) of lithium in the geothermal water source using predetermined extraction efficiencies. Similar analysis can be performed for elements such as magnesium (Mg), sodium (Na), and/or calcium (Ca) if they are considered to be of commercial value. The mineral gathering system 116 can also estimate: the volume of water that is reinjected to the geothermal subsurface reservoir 202 for pressure, temperature and volume maintenance; and/or the volume of permeates produced for treatment or disposal based on the selected mineral extraction system technology. For instance, the mineral gathering system 116 can include equipment such as: monitored solar evaporation ponds needed for the precipitation ponds; chemical free lithium separation equipment, such as filter or membranes that can be made of material types that can include polymer membranes (PM), cation exchange membranes (CEM), and/or chemical based system (e.g., precipitation or intercalation); a combination thereof; and/or the like. The mineral gathering system 116 can be operably coupled to the economic analyzer 108 to provide the geochemistry data of the fluids.

The fluids can also be supplied to one or more treatment systems 118, which can perform one or more bacterial and/or chemical treatments. The one or more treatment systems 118 can be also be located pre and post the mineral extraction systems 116 to reduce impurities or potential contaminants in produced fluids. For example, treatment systems 118 can perform one or more: physical treatments (e.g., involving one or more filters or sedimentation tanks), chemical treatments (e.g., to adjust the pH, remove contaminants, and/or prevent bacterial growth), biological treatments (e.g., using microorganisms to break down organic contaminants), and/or disinfection treatments (e.g., using chemicals and/or ultra-violet light to eliminate bacteria or viruses).

Once the fluids have been treated, the fluids can be re-introduced into the geothermal subsurface reservoir 202 via the injection system 120. For example, the fluids can be delivered to one or more injection wells via one or more distribution pumps and/or pipes of the injection system 120. In various embodiments, the injection system 120 can be operably coupled with the one or more reservoir simulators 102. Thereby, the injection system 120 can provide the reservoir simulators 102 with injection data to update the composition of the reservoir modeled by the reservoir simulators 102. For instance, the injection data can characterize the volume, flow rates, and/or temperature of fluids reintroduced into the geothermal subsurface reservoir 202. The reservoir simulators 102 can utilize the injection data to model changes in: the composition of fluids contained within the geothermal subsurface reservoir 202, the pressure of fluids contained within the geothermal subsurface reservoir 202, and/or temperature distributions the geothermal subsurface reservoir 202. Additionally, in one or more embodiments, the reservoir simulators 102 can control one or more operations of the injection system 120 to optimize conditions within the geothermal subsurface reservoir 202 based on electricity production predictions and/or economic estimations generated by the economic analyzer 108.

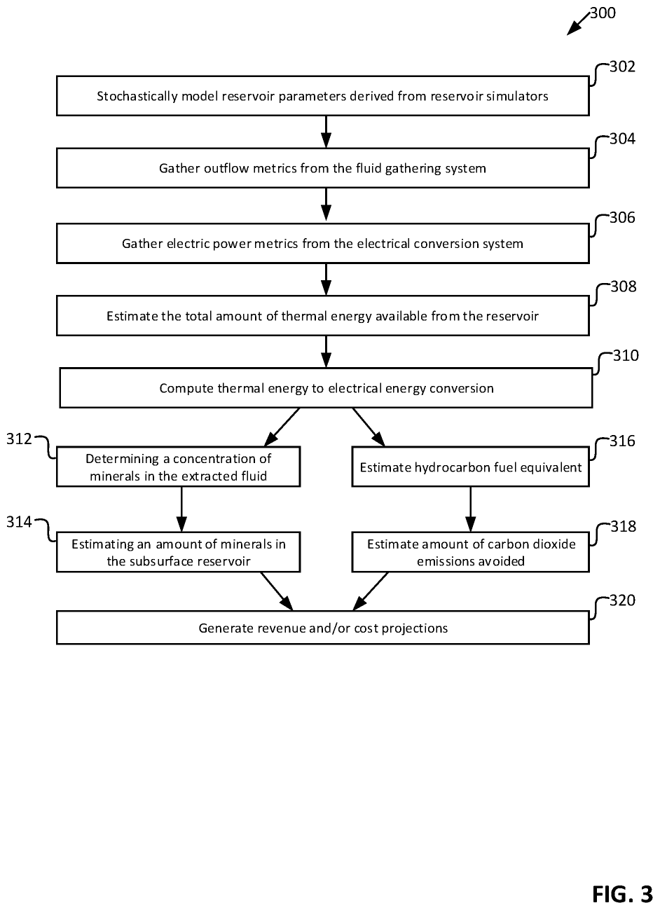

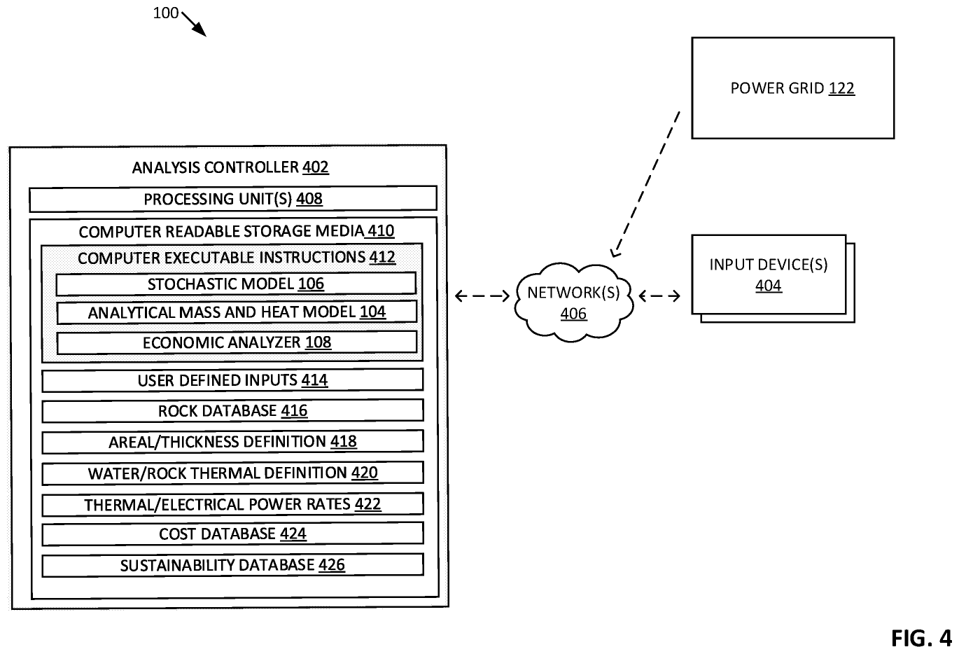

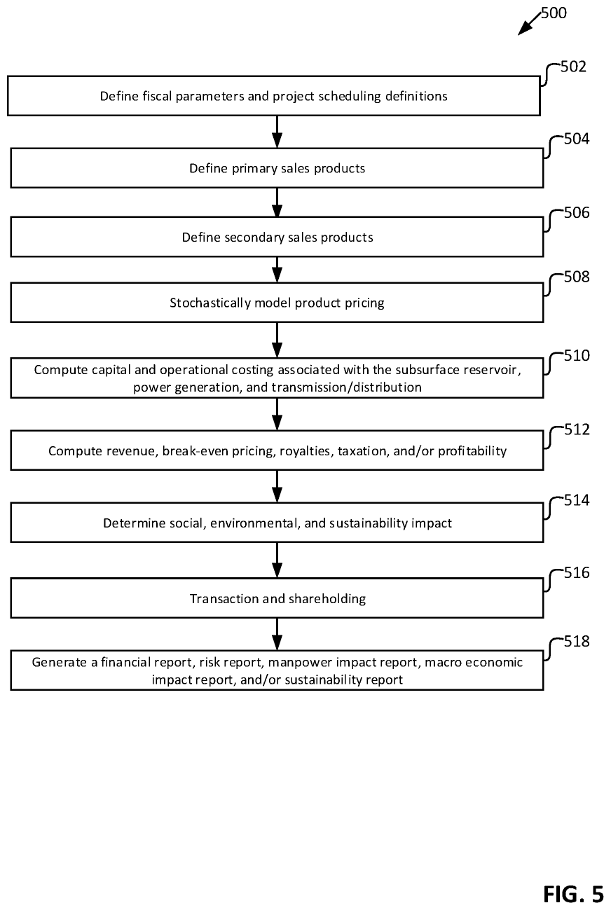

FIG. 3 illustrates a flow diagram of a non-limiting example computer-implemented method 300 that can be implemented by the system 100 to predict an amount of potential electrical power associated with a subsurface reservoir based on one or more reservoir simulators 102 and/or enhanced geothermal systems in accordance with one or more embodiments described herein. Various features of the computer-implemented method 300 can be executed in accordance with one or more features of the analysis controller 402 (e.g., illustrated in FIG. 4) and/or the computer-implemented method 500 shown in FIG. 5 and described further herein.

In view of the foregoing structural and functional features described above, example methods will be better appreciated with reference to FIG. 3. While, for purposes of simplicity of explanation, the example methods of FIG. 3 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

At 302, the computer-implemented method 300 can comprise stochastically modeling (e.g., via the stochastic model 106), via one or more processors (e.g., processing units 408) by the system 100, reservoir parameters derived from the one or more reservoir simulators 102. In accordance with one or more embodiments described herein, the stochastic model 106 can generate probability distributions associated with one or more reservoir parameters modeled by the one or more reservoir simulators 102. Example reservoir parameters that can be stochastically modelled include, but are not limited to: area of the subsurface reservoir; volume of the subsurface reservoir, mineral concentration of the subsurface reservoir (e.g., derived from the rock configuration of the subsurface reservoir); temperature of the subsurface reservoir; rock density and/or porosity of the subsurface reservoir; water configuration (e.g., water volume and/or water properties); utilized volume of the subsurface reservoir; pressure of the subsurface reservoir; derived parameters, such as: porosity reduction and pore volume reduction due to observed chemistry issues such as precipitation; a combination thereof; and/or the like.

At 304, the computer-implemented method 300 can comprise gathering (e.g., via the stochastic model 106 and/or the economic analyzer 108), by the system 100, fluid outflow metrics from the one or more fluid gathering systems 112. In accordance with one or more embodiments, the fluid gathering system 112 (e.g., via the one or more meters 210) can supply one or more fluid rates, volumes, and/or temperatures to the stochastic models 106 (e.g., as exemplified in FIG. 2). In one or more embodiments, the stochastic model 106 can stochastically model the fluid rates, volumes, and/or temperatures to quantify inherent variations in the characteristics of fluid extraction. Based on the observed volume and/or temperature of the fluid, the stochastic model 106 can compute an amount of thermal energy associated with the extracted fluid in accordance with various embodiments described herein. Additionally, the stochastic model 106 can compute a thermal power rate associated with the fluid extraction as a function of the amount of thermal energy and/or the flow rate measured by the fluid gathering system 112.

At 306, the computer-implemented method 300 can comprise gathering (e.g., via the stochastic model 106 and/or the economic analyzer 108), by the system 100, electric power metrics such as conversion efficiency for the selected electricity conversion system 114. In accordance with one or more embodiments described herein, the electrical conversion system 114 can supply the one or more stochastic models 106 with data indicating: the amount of electrical power generated by the electrical conversion system 114 from the extracted fluid and/or received from the power grid 122. In one or more embodiments, the stochastic model 106 can stochastically model the amount of electrical energy generation to quantify inherent variations in the characteristics of the electrical conversion. Based on the amount of thermal energy associated with the extracted fluid and the amount of electrical energy generated by the extracted fluid, the stochastic model 106 can compute a thermal energy to electrical energy conversion function. Additionally, the stochastic model 106 can compute a thermal power to electrical power conversion function based on the thermal power of the extracted fluid and an electrical power generated by the electrical conversion system 114 (e.g., as defined by the electrical conversion system 114).

At 308, the computer-implemented method 300 can comprise estimating (e.g., via the stochastic model 106 and/or the reservoir simulators 102), by the system 100, the total amount of thermal power available from the subsurface reservoir. In accordance with one or more embodiments described herein, the amount of potential thermal energy associated with the subsurface reservoir can be determined by the one or more reservoir simulators 102 and modeled by the one or more stochastic models 106. In another example, the one or more stochastic models 106 can determine the amount of potential thermal power as a function of one or more reservoir parameters provided by the one or more reservoir simulators 102. Further, in one or more embodiments the one or more reservoir simulators 102 can estimate an optimal flow rate at which the fluid can be extracted from the subsurface reservoir, and the stochastic model 106 can model the estimated optimal flow rate across a probability distribution.

At 310, the computer-implemented method 300 can comprise computing (e.g., via the stochastic model 106 and/or the economic analyzer 108), by the system 100, a thermal energy to electrical energy conversion associated with the subsurface reservoir based on the conversion function determined at 306. For example, the conversion function can be determined based on observed performance data collected from the enhanced geothermal system (e.g., from the production system 110, fluid gathering system 112, and/or electrical conversion system 114). Further, the stochastic model 106 and/or the economic analyzer 108 can utilize the determined energy conversion function to correlate the estimated thermal energy potential of the subsurface reservoir to an estimated potential amount of electrical energy associated with the subsurface reservoir in accordance with various embodiments described herein. Likewise, the stochastic model 106 and/or the economic analyzer 108 can utilized the determined power conversion function to correlate the estimated optimal fluid outflow rate to an estimated electrical power rate associated with the subsurface reservoir in accordance with various embodiments described herein.

At 312, the computer-implemented method 300 can comprise determining (e.g., via the mineral gathering system 116), by the system 100, a concentration of minerals (e.g., REEs, lithium oxide, and/or lithium carbonate equivalents) comprised within the extracted fluid. In accordance with one or more embodiments described herein, the mineral gathering system 116 can determine an observed amount and/or concentration of extracted minerals contained within the fluid based on one or more geochemical analyses. Further, the mineral gathering system 116 can provide the economic analyzer 108 with mineral data characterizing the amount of minerals detected, the concentration of minerals, and/or the type of minerals detected in the extracted fluids. Additionally, the mineral gathering system 116 can report the volume of water processed prior and post mineral extraction. If there are permeates or waste water to be disposed of this can be quantified by the mineral gathering system 116.

At 314, the computer-implemented method 300 can comprise estimating (e.g., via the economic analyzer 108), by the system 100, an amount and/or concentration of minerals in the subsurface reservoir. For example, the economic analyzer 108 can correlate the observed mineral concentration with the estimated volume of fluid in the subsurface reservoir to estimate an amount of targeted minerals contained within the subsurface reservoir using user defined mineral extraction efficiencies. In one or more embodiments, the stochastic model 106 can compute probability distributions characterizing a likelihood that the subsurface reservoir has a similar mineral concentration as the observed concentration in the extracted fluid based on, for example, the more reservoir models generated by the one or more reservoir simulators 102. In another example, the mineral gather system 116 can determine an amount of minerals collected from the extracted fluid, and the economic analyzer 108 can estimate a mineral concentration based on the volume of fluid, as determined by the fluid gathering system 112.

At 316, the computer-implemented method 300 can comprise estimating (e.g., via the economic analyzer 108), by the system 100, an amount of hydrocarbon fuel that can generate an equivalent amount of electrical energy and/or power. In accordance with one or more embodiments, the economic analyzer 108 can reference one or more hydrocarbon databases populated with energy data associated with various types of hydrocarbon fuel alternatives. For instance, the hydrocarbon databases can delineate an amount of electrical energy and/or power that can be generated for a defined volume of a given hydrocarbon fuel alternative (e.g., an alternative to the geothermal fluid extracted from the subsurface reservoir). Based on the energy data, the economic analyzer 108 can determine how much of one or more hydrocarbon fuel alternatives would be required to generate the same electrical energy and/or power as the estimated electrical energy and/or power associated with the subsurface reservoir (e.g., as determined at 310).

At 318, the computer-implemented method 300 can comprise estimating (e.g., via the economic analyzer 108), by the system 100, an amount of greenhouse gases emissions (e.g., carbon dioxide emissions) that can be avoided by utilizing the geothermal subsurface reservoir to general electricity than the one or more hydrocarbon fuel alternatives analyzed at 316. For example, the energy data can also delineate an amount of greenhouse gases gas emissions that result from the defined electrical production associated with defined volume of hydrocarbon fuel. Thereby, the economic analyzer 108 can compute an amount of negated greenhouse emissions based on the estimated amount of required hydrocarbon fuel, as determined at 316, and the greenhouse gases emission rate associated with the hydrocarbon fuel. The option to correct greenhouse gasses emission using global warming potential factor is included at 318. Such can be derived from the American Petroleum Institute (“API”): Compendium of greenhouse gas emissions methodologies for the natural gas and oil industry (Annual editions).

As shown in FIG. 3, in various embodiments the computer-implemented method 300 can perform features 312-314 independent of features 316-318. For example, the computer-implemented method 300 can perform features 312-314 concurrently, or near concurrently, with features 316-318.

At 320, the computer-implemented method 300 can comprise generating (e.g., via the economic analyzer 108), by the system 100, economic reports that can include revenue and/or cost projections associated with utilizing the subsurface reservoir as a geothermal source for electrical power. In accordance with one or more embodiments described herein, the economic analyzer 108 can generate the one or more economic reports by implemented computer-implemented method 500 described further herein with reference to FIG. 5. For example, the economic analyzer 108 can compute a revenue associated with the subsurface reservoir based on: the total estimated electrical energy and/or power associated with the subsurface reservoir, a value of the minerals estimated to be comprised within the subsurface reservoir, and/or available carbon dioxide credits.

For instance, the economic analyzer 108 can compute an amount of revenue that may be realized from harvesting thermal energy from the subsurface reservoir as electrical energy based on the estimated amount of electrical energy and/or power associated with the subsurface reservoir and a predicted electrical sales rate (e.g., a predicted marketplace value associated with the sale of electricity by the electrical conversion system 114 to the power grid 122). In another instance, the economic analyzer 108 can compute an amount revenue that may be realized from harvesting minerals from the subsurface reservoir.

FIG. 4 illustrates an example embodiment in which the system 100 can perform the electricity generation prediction and/or economic analysis based on one or more user defined inputs and/or the analytical mass and heat model 104 in accordance with one or more embodiments described herein. In one or more embodiments, the stochastic model 106, the economic analyzer 108, and/or the one or more analytical mass and heat models 104 can be incorporated into a standalone application implemented via one or more analysis controller 402. In various embodiments, the one or more analysis controller 402 (e.g., a server, a desktop computer, a laptop, a hand-held computer, a programmable apparatus, a minicomputer, a mainframe computer, an Internet of things (“IoT”) device, and/or the like) can be operably coupled to (e.g., communicate with) the power grid 122 and/or one or more input devices 404 via one or more networks 406.

As shown in FIG. 4, the one or more analysis controllers 402 can comprise one or more processing units 408 and/or computer readable storage media 410. In various embodiments, the computer readable storage media 410 can store one or more computer executable instructions 412 that can be executed by the one or more processing units 408 to perform one or more defined functions. In various embodiments, the stochastic model 106, economic analyzer 108, and/or analytical mass and heat model 104 can be computer executable instructions 412 and/or can be hardware components operably coupled to the one or more processing units 408. Additionally, in one or more embodiments the one or more reservoir simulators 102 can be computer executable instructions 412 operably coupled to the one or more processing units 408. For instance, in some embodiments, the one or more processing units 408 can execute the stochastic model 106, economic analyzer 108, and/or analytical mass and heat model 104 to perform various functions described herein (e.g., estimating electrical generation and/or performing economic analyses). Additionally, the computer readable storage media 410 can store various definitions characterizing properties of a given subsurface reservoir, such as user defined inputs 414, a rock database 416, an aerial/thickness definition 418, a water/rock thermal definition 420, thermal/electrical power rates 422, a cost database 424, and/or a sustainability database 426.

The one or more processing units 408 can comprise any commercially available processor. For example, the one or more processing units 408 can be a general purpose processor, an application-specific system processor (“ASIP”), an application-specific instruction set processor (“ASIPs”), or a multiprocessor. For instance, the one or more processing units 408 can comprise a microcontroller, microprocessor, a central processing unit, and/or an embedded processor. In one or more embodiments, the one or more processing units 408 can include electronic circuitry, such as: programmable logic circuitry, field-programmable gate arrays (“FPGA”), programmable logic arrays (“PLA”), an integrated circuit (“IC”), and/or the like.

The one or more computer readable storage media 410 can include, but are not limited to: an electronic storage device, a magnetic storage device, an optical storage device, an electromagnetic storage device, a semiconductor storage device, a combination thereof, and/or the like. For example, the one or more computer readable storage media 410 can comprise: a portable computer diskette, a hard disk, a random access memory (“RAM”) unit, a read-only memory (“ROM”) unit, an erasable programmable read-only memory (“EPROM”) unit, a CD-ROM, a DVD, Blu-ray disc, a memory stick, a combination thereof, and/or the like. The computer readable storage media 410 can employ transitory or non-transitory signals. In one or more embodiments, the computer readable storage media 410 can be tangible and/or non-transitory. In various embodiments, the one or more computer readable storage media 410 can store the one or more computer executable instructions 412 and/or one or more other software applications, such as: a basic input/output system (“BIOS”), an operating system, program modules, executable packages of software, and/or the like.

The one or more computer executable instructions 412 can be program instructions for carrying out one or more operations described herein. For example, the one or more computer executable instructions 412 can be, but are not limited to: assembler instructions, instruction-set architecture (“ISA”) instructions, machine instructions, machine dependent instructions, microcode, firmware instructions, state-setting data, configuration data, source code, object code, a combination thereof, and/or the like. For instance, the one or more computer executable instructions 412 can be written in one or more procedural programming languages. Although FIG. 4 depicts the computer executable instructions 412 stored on computer readable storage media 410, the architecture of the system 100 is not so limited. For example, the one or more computer executable instructions 412 can be embedded in the one or more processing units 408.

The one or more networks 406 can comprise one or more wired and/or wireless networks, including, but not limited to: a cellular network, a wide area network (“WAN”), a local area network (“LAN”), a combination thereof, and/or the like. One or more wireless technologies that can be comprised within the one or more networks 406 can include, but are not limited to: wireless fidelity (“Wi-Fi”), a WiMAX network, a wireless LAN (“WLAN”) network, BLUETOOTH® technology, a combination thereof, and/or the like. For instance, the one or more networks 406 can include the Internet and/or the IoT. In various embodiments, the one or more networks 406 can comprise one or more transmission lines (e.g., copper, optical, or wireless transmission lines), routers, gateway computers, and/or servers. Further, the one or more analysis controllers 402 can comprise one or more network adapters and/or interfaces (not shown) to facilitate communications via the one or more networks 406.

In various embodiments, the one or more input devices 404 can be employed to enter data (e.g., assessment information described herein) into the system 100 that characterizes one or more properties of a given subsurface reservoir. Example user defined inputs that can be entered into the system 100 via the one or more input devices 404 can include, but are not limited to: temperature gradients, rock type, rock properties, water properties, heat capacities, areal extent of reservoir, thickness of a reservoir, a combination thereof, and/or the like. In various embodiments, the one or more input devices 404 can comprise and/or display one or more input interfaces (e.g., a user interface) to facilitate entry of data into the system 100. Additionally, in one or more embodiments the one or more input devices 404 can be employed to define one or more system 100 settings, parameters, definitions, preferences, thresholds, and/or the like. Also, in one or more embodiments the one or more input devices 404 can be employed to display one or more outputs from the one or more analysis controllers 402 and/or query one or more system 100 users. For example, the one or more input devices 404 can send, receive, and/or otherwise share data (e.g., inputs and/or outputs) with the analysis controller 402 (e.g., via a direct electrical connection and/or the one or more networks 406).

The one or more input devices 404 can comprise one or more computer devices, including, but not limited to: desktop computers, servers, laptop computers, smart phones, smart wearable devices (e.g., smart watches and/or glasses), computer tablets, keyboards, touch pads, mice, augmented reality systems, virtual reality systems, microphones, remote controls (e.g., an infrared or radio frequency remote control), stylus pens, biometric input devices, a combination thereof, and/or the like. Additionally, the one or more input devices 404 can comprise one or more displays that can present one or more outputs generated by, for example, the analysis controller 402. Example displays can include, but are not limited to: cathode tube display (“CRT”), light emitting diode display (“LED”), electroluminescent display (“ELD”), plasma display panel (“PDP”), liquid crystal display (“LCD”), organic light-emitting diode display (“OLED”), a combination thereof, and/or the like.

For example, the one or more input devices 404 can be employed to define one or more types of rock that characterizes the subsurface reservoir. Based on the rock type designation, the stochastic model 106 can define a rock definition based on one or more rock properties defined in the one or more rock databases 416. For example, the one or more rock databases 416 can be populated with various properties and/or mineral contents associated with respective rock types. For instance, for respective rock types (e.g., kaolinite, basalt, limestone, granite, feldspar, calcite, dolomite, quartz, marble, sandstone, and/or the like), the one or more rock databases 416 can delineate a density value, heat capacity, and/or miner content. Further, the stochastic model 106 can utilize a stochastic function or weighting parameter to define variations in rock quality in line with geological attributes and depositional characteristics of the reservoir. For example, the stochastic model 106 can compute a rock properties value in accordance with Equation 1 below.

$$Rock definition = ( stochastic quality function weight * rock density * heat capacity ) \qquad ( 1 )$$

The total heat energy of a geothermal system is the sum of rock heat content, trapped water heat, and mobile water heat content for the given subsurface volume. The rock heat is a product of the rock volume excluding the void spaces or porosity. The rock heat definition is a product of the rock density (e.g., mass unit per unit volume units) and heat capacity (e.g., energy per unit of mass- and temperature units) for the given rock type. However due to the reservoir heterogeneity and mixture of several rock types with different rock densities, a stochastic quality function derived by the one or more stochastic models 106 can be used to provide a multiplier to achieve of an effective (e.g., average) rock density with average heat capacities that account for all rock types to be used for heat energy estimate. In one or more embodiments, the one or more reservoir simulators 102 can determine and/or consider rock heterogeneity.

In another example, the one or more input devices 404 can be employed to define one or more water properties associated with the subsurface reservoir. For instance, the stochastic model 106 can computer water property values in accordance with Equation 2 below.

$$Water definition = ( stochastic quality function weight * water density * water heat capacity ) \qquad ( 2 )$$

The water heat is a product of the water volume within the void spaces or porous media. The water heat definition is a product of the water density (e.g., mass unit per unit volume units) and heat capacity (e.g., energy per unit of mass- and temperature units) for the given water type. Water type is affected by geochemical chemistry of the water within the subsurface reservoir. Poor water chemistry can lead to scaling and reservoir permeability reduction that reduces rock performance and subsequently heat generation. Due to the reservoir heterogeneity and mixture of several water types with different chemistry compositions, a stochastic quality function can be derived by the one or more stochastic models 106 to provide a multiplier to achieve of an effective or average density to account for all potential water chemistry types to be used for heat energy estimate. In one or more embodiments, the one or more reservoir simulators 102 can determine and/or consider water mixture compositions.

In a further example, an area of the reservoir can be imported from an existing grid model. Alternatively, the one or more input devices 404 can be employed to define geographical coordinates that the stochastic model 106 can utilize alongside a stochastic function, geological probability of success, and/or rock characteristics in accordance with Equation 3 below.

$$Areal definition = stochastic geological probability * stochastic aquifer / reservoir ratio * stochastic areal utilization function * stochastic rock thickness * rock flow capacity \qquad ( 3 )$$

The stochastic geological probability can be derived from multiple runs of the stochastic model 106 and can be intended to correct the areal definition when calculated for new unexplored location or area with unconfirmed areal sizes. It is similar to geological success that establishes the probability of encountering a geothermal reservoir. For example, a MCS probability function employed by the stochastic model 106 can be determined based on a discrete criterion of nonexistent, expected (e.g., if intended geothermal reservoir exists), or high success (e.g., if the geothermal reservoir exceeds its expected area). These discrete values can be assigned by the working knowledge of the subsurface engineer. The stochastic aquifer/reservoir ratio can be an MCS parameter used for the EGS reservoirs, low enthalpy systems of geothermal systems from discussed oil fields, where the area of the previous or producing zone is known. The aquifer ratio is a multiplier that estimates the areal extent of a geothermal opportunity for aquifers that lie below a known accumulation. As an example, aquifer/reservoir ratio of 10 times demonstrates that the geothermal area for the given aquifer is 10 times more that the given or known reservoir accumulation. Due to presence of geothermal opportunities in some places of human habitation and inability for most geothermal developments to access all extent of the reservoir heat, the stochastic areal utilization is an MCS derived factor that quantifies the probability of the extent of section of the geothermal opportunity that can be recovered based on the existing technologies. For example given an area of 100 mile square with the opportunity to drill only two wells with 5 mile square drainage are each, the areal consideration for conservatively computing the geothermal potential is 10%. The rock thickness and/or flow can be either defined by the user as derived from representative electric log data if measured. If not measured then the user has an option of including this in the analytical mass and heat model 104. In one or more embodiments, the one or more reservoir simulators 102 can determine the rock thickness and/or flow capacity.

In various embodiments, the one or more mass and heat models 104 can compute a total amount of heat energy available from the given subsurface reservoir. For instance, the one or more mass and heat models 104 can utilize the USGS equation to estimate the amount of thermal energy stored in a reservoir alongside a wellbore configuration utilized to extract fluids from the reservoir in accordance with Equation 4 below. The resource area refers to the proportion or size of the total area that can be exploited for geothermal energy. This proportion as a percentage is derived from stochastic modelling (e.g., via the one or more stochastic models 106) after accounting for operating conditions, such as: well spacing, accessibility, and drilling technologies (e.g., extended drilling). The areal extent or definition of the field is the actual geographical area of the asset and can include built areas that may not be accessible for geothermal extraction. The resource area is a product of areal extent and stochastically derived proportion. Typical values of resource are can be from about 2% to about 25%

Heat Energy Available=resources area*well depth*(rock heat content+water heat content) (4)

Additionally, the stochastic model 106 can estimate an amount of thermal power associated with the subsurface reservoir based on the heat energy available in accordance with Equation 5 below. The stochastic recovery factor represents how much of geothermal energy can be exploited for the given period of time. Thus, the stochastic recovery factor is a time dependent variable and represents the percentage or fraction of the total useful geothermal energy that can be exploited for the given resource area using the given technologies, conversion methods within the given project and operating time frames set by the user. Typical recovery factors can range from about 12 to about 22%. The project life refers to the fixed period of economic use of the project and represents the period from first production for the given facilities to the end of production from same facilities due to these facilities reaching a technical and economic end of life. Typical values of project life for a geothermal is about 25 years that can be enhanced with new capital investment or facilities. The operating or load factor defines the producing time for a given year after excluding time for scheduled maintenance and variations in energy demand from users. Due to tendency for unscheduled non-producing times, the one or more stochastic models 106 can derive the operating factor as a percentage or fraction. Typical values of operating factors can range from about 70% to about 96% (e.g., a value of about 0.7 to about 0.96). The heat mass computations are used to determine the amount of heat that is available for the resource area for the given temperatures and physical attributes of rock and water. Thermal power is the heat energy produced from the surface facilities to the customers for a day (e.g., 24 hours). For example, the thermal power is the heat energy available at surface for a given recovery factor, project life, operating time and the conversion efficiency of the technologies used.

$$Thermal Power = stochastic recovery factor * project life * design efficiency * operating factor \qquad ( 5 )$$

Further, the stochastic model 106 can estimate an amount of electrical power associated with the subsurface reservoir based on the estimated thermal power in accordance with Equation 6 below.

$$Electrical Power = generator efficiency * transmission loss * thermal power \qquad ( 6 )$$

The generator efficiency can be manufacturer recommended or user defined. In one or more embodiments, there is an option to stochastically define the electricity conversion using statistical data derived from similar geothermal technologies globally. In various embodiments, the thermal power and electrical power estimations can be the product of iterative simulations using probability and cumulative distribution functions from inputs, which are in turn derived from, for example, uniform distribution, triangular distribution, normal distribution, discrete distribution, and/or the like. For example, stochastic model 106 can determine a probability of occurrence associated with a provided thermal power and/or electrical power estimation (e.g., the thermal and/or electrical power estimate can be associated with a 10 percent, 50 percent, or 90 percent probability of occurrence).

In one or more embodiment, the economic analyzer 108 can execute one or more hydrocarbon fuel equivalent and/or carbon dioxide avoidance computations; thereby, the economic analyzer 108 can estimate sustainability benefits associated with using the geothermal energy available via the subsurface reservoir. For example, the economic analyzer 108 can calculate the hydrocarbon fuel equivalent value in accordance with Equation 7 below to forecast the energy requirement to produce the same quantity of electrical power using alternative hydrocarbon fuel sources (e.g., gasoline, diesel, natural gas, and/or fuel oil).

$$Hydrocarbon Fuel Equivalent = ( Grid Electrical Power / ( hydrocarbon fuel * generator efficiency ) \qquad ( 7 )$$

Further, the economic analyzer 108 can estimate the amount of carbon dioxide avoidance in accordance with Equation 8 below.

$$Carbon Dioxide Avoidance = amount of hydrocarbon fuel equivalent * carbon dioxide emission rate of the hydrocarbon fuel \qquad ( 8 )$$

Where the amount of hydrocarbon fuel equivalent is the amount of a hydrocarbon fuel that would be need to produce an equivalent amount of electricity that is produced from the thermal energy captured by the extracted reservoir fluids.

In one or more embodiments, the economic analyzer 108 can further estimate mineral extraction associated with the subsurface reservoir in accordance with Equation 9 below.

$$Mineral Estimation = mineral \text{} concentration * \text{} water mass \text{} / \text{} volume rate * depletion rate * membrane efficiency * operating factor * mineral carbon equivalent \qquad ( 9 )$$

Mineral concentration is derived from measurement and geochemistry analysis that test for the presence of ions and anions in water samples. A range of values of mineral concentration can be regionally obtained and stochastically modelled (e.g., via the one or more stochastic models 106) for an estimate in new or unexplored regions. The water mass or volume rate can be an output of the one or more reservoir simulation models 102. In one or more embodiments, a predefined forecast can be utilized when employing the one or more analytical mass and heat models 104. Similarly, the depletion rate can be derived from the one or more reservoir simulators 102 and can characterize the rate at which the water mass or volume rate reduces with time. Where the simulator option is not used then user defined depletion rate of water can be considered. Membrane efficiency can be product specific and manufacturer design dependent. The efficiency of a membrane depends on its permeance and selectivity combination. The permeance determines the amount of flow of effluents through a unit area of membrane material. The selectivity of a membrane represents the ability to select specific ions from an effluent flowing through the membrane area. The membrane efficiency is a user defined parameter that is derived from the manufacturer data. The mineral carbon equivalent metric can standardize the volume of a mineral resources to standard carbon equivalent that assumes the mineral is converted into a new compound. As an example, lithium that is the common explored mineral from geothermal waters can be converted to a lithium carbonate equivalent (Li₂CO₃) that ensure consistency in reporting the volumes for commercial valuations by users or other competent persons required to report volumes or other commercial interests internationally. Specific for lithium, other standards such as lithium oxide and lithium hydroxide equivalents can be used to represent global standards in extracted mineral volume.

Further, in one or more embodiments, one or more the user defined inputs 414 can define one or more thresholds values for the assessment at step 109. For example, the analysis controller 402 can compare one or more outputs of the economic analyzer 108 with one or more predefined thresholds to determine whether modelled reservoir and/or production parameters are predicted to successfully achieve a target object (e.g., characterized by the threshold metrics).

FIG. 5 illustrates a flow diagram of a non-limiting example computer-implemented method 500 that can be implemented by the economic analyzer 108 to generate economic reports (e.g., economic report, risk report, manpower impact report, macro-economic impact report, and sustainability report) in accordance with one or more embodiments described herein. In various embodiments, one or more features of computer-implemented method 500 can be executed by the analysis controller 402.

In view of the foregoing structural and functional features described above, example methods will be better appreciated with reference to FIG. 5. While, for purposes of simplicity of explanation, the example methods of FIG. 5 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

At 502, the computer-implemented method 500 can comprise defining (e.g., via the economic analyzer 108 and/or input devices 404), by one or more processors (e.g., processing units 408) operably coupled to a system 100, one or more fiscal parameters and/or project scheduling definitions associated with the subsurface reservoir. In one or more embodiments, the fiscal parameters and/or project scheduling definitions can be predefined or can be defined by one or more users of the system 100 via the one or more input devices 404. For instance, the fiscal parameters can characterize taxation conditions for project profits, discount rate or weighted cost of capital for funding of geothermal projects, inflation rate expected from maintaining and operating geothermal facilities, royalty payments expected, a combination thereof, and/or the like. Example fiscal parameters can include, but are not limited to: tax percentage rate, interest rate percentages, inflation rate percentages, carbon emissions credit rate, a combination thereof, and/or the like. In another instance, the project scheduling can define a duration of the project employed to harvest geothermal energy from the subsurface reservoir. In some instances, the project scheduling definitions can further delineate periods of times (e.g., seasons) during which geothermal energy is planned to be harvested and periods of time during which energy harvesting operations associated with the subsurface reservoir may be paused. Thereby, the economic analyzer 108 can compute total duration of the project (e.g., the project's life) based on the defined project scheduling definitions.

At 504, the computer-implemented method 500 can comprise defining (e.g., via the economic analyzer 108), by the system 100, primary sales products. In one or more embodiments, the production of electricity can be defined as the primary sales product associated with the subsurface reservoir. For example, harvesting geothermal energy from the subsurface reservoir to produce electricity to supply to the power grid 122 can be defined as the primary means of revenue associated with the subsurface reservoir. At 506, the computer-implemented method 500 can comprise defining (e.g., via the economic analyzer 108), by the system 100, one or more secondary products. For example, harvesting targeted minerals (e.g., REE) from the subsurface reservoir can be defined as a secondary means of revenue associated with the subsurface reservoir. In one or more embodiments, multiple secondary products can be defined at 506 (e.g., the subsurface reservoir can be associated with three or more means of revenue).

At 508, the computer-implemented method 500 can comprise stochastically modelling (e.g., the economic analyzer 108 and/or the stochastic model 106), by the system 100, product pricing. For example, the stochastic model 106 can stochastically model pricing associated with each of the primary sales products and/or the secondary sales products (e.g., as defined at 504 and/or 506). For instance, the sales price of electricity supplied to the power grid 122 may vary depending on supply and demand. During periods of high demand and low supply, sales prices for electric power can increase; whereas during periods of low demand and/or high supply, sales prices for electric power can decrease. In one or more embodiments, the stochastic model 106 can be provided one or more price forecasts associated with the sales price of electricity (e.g., where the forecasts can be provided by one or more systems of the power grid 122, the one or more input devices 404, and/or an external pricing model), and the stochastic model 106 can quantify the uncertainty and/or variability of the price forecasts. Likewise, price forecasts can be modeled for one or more other sales products (e.g., secondary sales products), such as the sales price for minerals that may be extracted from the subsurface reservoir.

At 510, the computer-implemented method 500 can comprise computing (e.g., via the economic analyzer 108), by the system 100, capital and/or operational costs associated with the subsurface reservoir, power generation, and/or transmission/distribution of the electricity. For example, capital and/or operational costs can be computed by the economic analyzer 108 based on one or more reservoir parameters (e.g., modeled by the one or more stochastic models 106) derived from reservoir simulators 102, analytical heat and mass models 104, and/or input devices 404.

In one or more embodiments, economic analyzer 108 can reference one or more cost databases 424 that define various cost relationships associated with one or more reservoir parameters. Based on the cost relationships defined by the cost databases 424 and the estimated reservoir parameter values, the economic analyzer 108 can compute one or more capital and/or operational costs. For instance, the cost database 424 can include a cost relationship that defines a capital cost for drilling a well as a function of depth and/or surrounding rock type. In another instance, the cost database 424 can include an operational cost for operating and/or maintaining the well as a function of, for example, depth and/or surrounding rock type. In a further instance, the cost database 424 can include an operational cost for running a fluid recycling system (e.g., such as the treatment system 118 and/or the injection system 120) to maintain a desired pressure within the subsurface reservoir as a function of, for example, the volume of fluid and/or fluid rate required to achieve the desired pressure.

In one or more embodiments, the one or more cost databases 424 can further define various cost relationships associated with converting the geothermal energy into electricity and/or distributing the electricity. Based on the cost relations defined in the cost database 424 and estimated electricity conversion system 114 parameters, the economic analyzer 108 can compute one or more capital and/or operational costs. For instance, the cost database 424 can include a cost relationship that defines a capital cost for establishing a electricity conversion system 114 and/or electricity distribution system as function of, for example, infrastructure and/or equipment parameters characterizing a coupled electricity conversion system 114 and/or a planned electrical conversion system 114 (e.g., where the one or more input devices 404 can be employed to define characteristics of a planned electrical conversion system 114 to be built to harvest the geothermal energy). In another instance, the cost database 424 can include a cost relationship that defines an operational cost for operating and/or maintaining the coupled electricity conversion system 114 and/or planned electricity conversion system 114 as a function of, for example, the electricity conversion system 114 parameters and/or the project life (e.g., as defined at 502).

At 512, the computer-implemented method 500 can comprise computing (e.g., via the economic analyzer 108), by the system 100, revenue, breakeven pricing, royalties, taxation, and/or profitability. In one or more embodiments, the computer-implemented method 500 can comprise computing (e.g., via the economic analyzer 108) revenue streams associated with each of the defined sales products.

For example, the economic analyzer 108 can compute an estimated revenue associated with the subsurface reservoir based on the estimated amount of electricity (e.g., computed in accordance with Equations 1-6 described herein) that can be supplied to the power grid 122 over the project's life and the estimated sales price (e.g., stochastically modeled) of electricity over the project's life. For instance, the estimated revenue can be summation of one or more revenue periods (e.g., defined by the project scheduling definitions), where each revenue period can define a portion of the estimated revenue as the estimated electrical power supplied to the power grid 122 (e.g., in accordance with Equation 6 described herein) over a defined time period multiplied by the sales price predicted to be paid by the power grid 122 over the defined time period.

In an additional example, the economic analyzer 108 can compute the estimated revenue based further on the estimated amount and/or type of minerals that can be extracted from the subsurface reservoir over the project's life and the estimated sales price of the minerals over the project's life. For instance, the estimated revenue associated with the mineral extraction can be a summation of one or more mineral revenue periods (e.g., defined by the project scheduling definitions), where each mineral revenue period can define a portion of the estimated mineral revenue as the amount of defined mineral type estimated to be extracted over a defied time period multiplied by the sales price predicted to be associated with the mineral over the defined time period.

In one or more embodiments, the economic analyzer 108 can compute one or more break-even price points associated with the defined sales products. For example, the economic analyzer 108 can define the break-even price points as sales prices of the sales products that result in the estimated revenue equaling the estimated cost (e.g., the capital and/or operational costs estimated at 510). For instance, the economic analyzer 108 can compute one or more combinations of sales prices associated with the one or more sales products that can result in the total estimated revenue associated with the subsurface reservoir equaling the total costs associated with building and/or running the subsurface reservoir harvesting operations. Additionally, in one or more embodiments the economic analyzer 108 can compute one or more probability values associated with the one or more break-even points based on the stochastic models characterizing the revenue and/or cost input parameters. In one or more embodiments, the economic analyzer 108 can compute a confidence score associated with the break-even price points based on probability values determined at 508 when modelling the product pricing (e.g., when stochastically modelling price forecasts).

In one or more embodiments, the economic analyzer 108 can compute one or more royalties that may be associated with leasing the land occupied by the subsurface reservoir. For example, a leasing agreement providing accesses the subsurface reservoir may define a royalty rate to be paid to the land lessor based on revenue from the primary and/or secondary sales products. For instance, the royalty rate can be entered into the system 100 via the one or more input devices 404. The amount paid in accordance with the royalty rate can be determined based on the estimated revenue computations and can be considered in the break-even pricing determination and/or profitability determination.

In one or more embodiments, the economic analyzer 108 can compute an estimated amount of taxes to be paid during a defined time period in monetizing the primary and/or secondary sales products. For example, sales of the primary and/or secondary sales products can be associated with a local, regional (e.g., state), and/or federal taxation rate, which can be defined via the one or more input devices 404. In one or more embodiments, the economic analyzer 108 can estimate the amount of periodic taxes (e.g. quarterly, annually, and/or the like) to be paid as a result of selling the primary and/or secondary products. In some embodiments, the economic analyzer 108 can estimate the amount of periodic taxes (e.g., quarterly, annually, and/or the like) to be paid as a result of operating the production system 110, fluid gathering system 112, electricity conversion system 114, mineral gathering system 116, treatment system 118, and/or injection system 120.

In various embodiments, the economic analyzer 108 can compute an estimated profitability associated with harvesting the primary and/or secondary products from the subsurface reservoir for a defined duration (e.g., the project's life). For example, the profitability estimate can be a function of the estimated revenue minus the estimated costs, royalties, and/or taxes. In one or more embodiments, the profitability can be associated with one or more defined durations of time (e.g., profitability over the next year, next three years, next five years, and/or the like).

At 514, the computer-implemented method 500 can comprise determining (e.g., via the economic analyzer 108), by the system 100, a social, environmental, and/or sustainability impact associated with harvesting geothermal energy and/or targeted minerals (e.g., REEs) from the subsurface reservoir. In various embodiments, the economic analyzer 108 can reference one or more sustainability databases 426 that contain social, environmental, and/or sustainability data previously collected with regards to one or more other geothermal energy projects. For example, the social, environmental, and/or sustainability data can include observational studies, monitoring, and/or impact assessments associated with historic geothermal energy projects. For instance, the social, environmental, and/or sustainability data can characterize: the impacts on communities local to an associated historic geothermal energy project; the displacement of residents and/or loss of traditional land uses associated with the operation of a historic geothermal energy project; the effects on air quality, water quality, biodiversity, and/or overall ecological heath of an environment in proximity to an associated historic geothermal energy project; a combination thereof, and/or the like.

In one or more embodiments, for each historic geothermal energy project characterized by the sustainability database 426, the economic analyzer 108 can compute a similarity score quantifying an amount of similarity between the characteristics of the given geothermal project and a historic geothermal project. For example, the economic analyzer 108 can compare, between the two geothermal projects: reservoir parameters, estimated thermal energy available, estimated amount of minerals available, location of the subsurface reservoirs, estimated project life, a combination thereof and/or the like. In one or more embodiments, the economic analyzer 108 can employ a machine learning model to compute the similarity score, such as, for example: a K-nearest neighbors model, a cosine similarity model, a Jaccard similarity model, a Euclidean distance model, a Mahalanobis distance model, a Siamese neural network model, a combination thereof, and/or the like. Where highest computed similarity score amongst the historic geothermal projects is also greater than a defined threshold, the economic analyzer 108 can estimate the social, environmental, and/or sustainability impact of the given geothermal project to be approximate to the social, environmental, and/or sustainability impact of the similar historic geothermal project. Further, should the given geothermal project be initiated, observational studies, monitoring, and/or impact assessments associated with the given geothermal project can be collected throughout the project's life and stored in the sustainability database 426 to facilitate future predictions.

In various embodiments, at 514 the economic analyzer 108 can also estimate amount of carbon dioxide emissions avoided by supplying electricity sourced from the subsurface reservoir, rather than from a hydrocarbon fuel source. For example, the amount of negated carbon dioxide emissions can be computed in accordance with step 318 of computer-implemented method 300 and/or Equations 7-8 described herein.

At 516, the computer-implemented method 500 can comprise collecting (e.g., via the economic analyzer 108), by the system 100, transaction and/or shareholding data from the one or more input devices 404. For example, the economic analyzer 108 can query the one or more input devices 404 to enter transaction and/or shareholding data into the system 100, which can characterize executed and/or planned agreements for the buying and/or selling of rights to develop and operate a production system 110, fluid gathering system 112, electricity conversion system 114, mineral gathering system 116, treatment system 118, and/or injection system 120 associated with the subsurface reservoir and/or given geothermal project. In one or more embodiments, the subject transaction can establish the revenue generation method for a given project. For instance, the transaction method can delincate details of the selling point or the transfer point of the product. In one or more embodiments, the product can be either the geothermal heat energy or thermal power prior to conversion to electricity or actual electricity post conversion and delivered to the buyer. The transaction data can characterize the differences in buying process and investment needed by a user of the system 100. The shareholding structure can delineate the owners and percentages of ownership for the entire geothermal project.

At 518, the computer-implemented method 500 can comprise generating (e.g., via the economic analyzer 108), by the system 100, one or more economic reports, which can include: a financial report, a risk report, a manpower impact report, a macro economic impact report, and/or a sustainability report. In one or more embodiments, the financial reports can include the pricing, cost, revenue, break-even pricing, royalty, taxation, and/or profitability computations determined at 502 to 512. In one or more embodiments, the risk report can include losses incurred if the pricing of the primary and/or secondary products falls below the break-even pricing. Additionally, the risk report can include one or more probability values associated with the one or more of the stochastic modeling operations described herein. For example, the risk report can include a probability value associated with a price forecast utilized to determine an estimated revenue associated with the given geothermal project. In one or more embodiments, the manpower impact report can include an estimate of the amount of labor associated with establishing, operating, and/or maintaining the given geothermal project. For example, the amount of labor can be estimated based on the labor requirements of similar historic geothermal projects (e.g., as defined in the sustainability database 426). In one or more embodiments, the macro-economic report can include national gross domestic product contribution from the geothermal project. The gross domestic product can be derived from the distribution of capital and revenues earned for the project life. Job creation is another macro-economic indicator that can be derived from labor cost and operating expenditures during the project life. In one or more embodiments, the sustainability report can include one or more of the determinations made at 514, such as the amount of negated carbon emissions.

In various embodiments, the economic analyzer 108 can share the one or more economic reports with one or more users of the system 100 via the one or more input devices 404. Based on the economic reports, the one or more users can decide to proceed with the geothermal project, not proceed with the geothermal project, and/or alter one or more inputs (e.g., user defined inputs 414) characterizing the geothermal project (e.g., whereupon one or more of the computer-implemented methods described herein can be repeated).

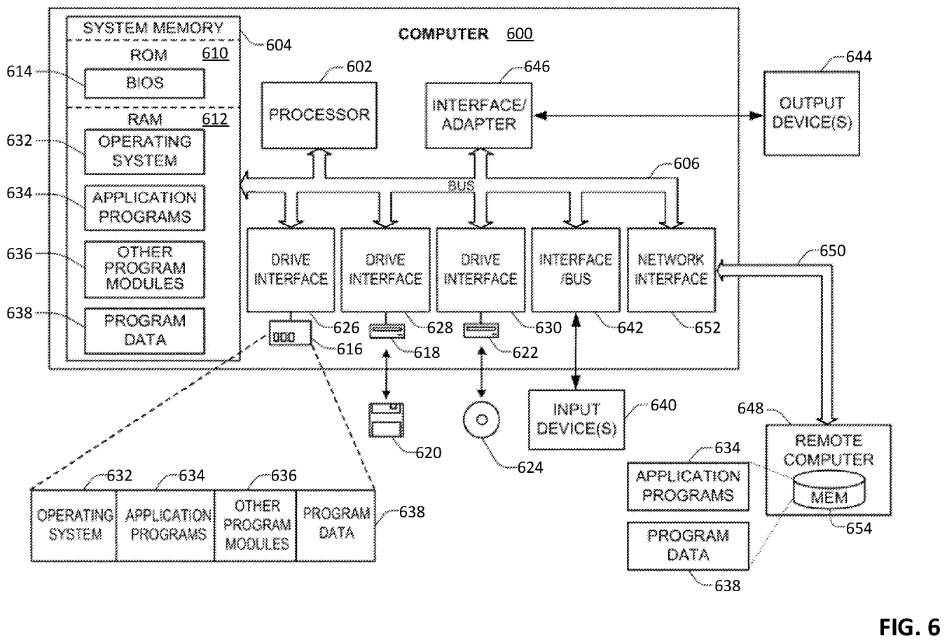

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 6. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 6 illustrates one example of a computer system 600 that can be employed to execute one or more embodiments of the present disclosure. Computer system 600 can be implemented on one or more general purpose networked computer systems, embedded computer systems, routers, switches, server devices, client devices, various intermediate devices/nodes or standalone computer systems. Additionally, computer system 600 can be implemented on various mobile clients such as, for example, a personal digital assistant (PDA), laptop computer, pager, and the like, provided it includes sufficient processing capabilities.

Computer system 600 includes processing unit 602, system memory 604, and system bus 606 that couples various system components, including the system memory 604, to processing unit 602. Dual microprocessors and other multi-processor architectures also can be used as processing unit 602. System bus 606 may be any of several types of bus structure including a memory bus or memory controller, a peripheral bus, and a local bus using any of a variety of bus architectures. System memory 604 includes read only memory (ROM) 610 and random access memory (RAM) 612. A basic input/output system (BIOS) 614 can reside in ROM 610 containing the basic routines that help to transfer information among elements within computer system 600.

Computer system 600 can include a hard disk drive 616, magnetic disk drive 618, e.g., to read from or write to removable disk 620, and an optical disk drive 622, e.g., for reading CD-ROM disk 624 or to read from or write to other optical media. Hard disk drive 616, magnetic disk drive 618, and optical disk drive 622 are connected to system bus 606 by a hard disk drive interface 626, a magnetic disk drive interface 628, and an optical drive interface 630, respectively. The drives and associated computer-readable media provide nonvolatile storage of data, data structures, and computer-executable instructions for computer system 600. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 610, including operating system 632, one or more application programs 634, other program modules 636, and program data 638. In some examples, the application programs 634 can include the stochastic model 106, analytical mass and heat model 104, and/or economic analyzer 108, and the program data 638 can include probability distributions modeled by the stochastic model 106 and/or various reports generated by the economic analyzer 108. The application programs 634 and program data 638 can include functions and methods programmed to predict electricity generations and/or REE extraction associated with a geothermal subsurface reservoir, such as shown and described herein.

A user may enter commands and information into computer system 600 through one or more input devices 640, such as a pointing device (e.g., a mouse, touch screen), keyboard, microphone, joystick, game pad, scanner, and the like. For instance, the user can employ input device 640 to edit or modify the one or more user defined inputs 414, areal/thickness definition 418, water/rock thermal definition 420, thermal/electrical power rates 422, cost database 424, and/or sustainability database 426. These and other input devices 640 are often connected to processing unit 602 through a corresponding port interface 642 that is coupled to the system bus, but may be connected by other interfaces, such as a parallel port, serial port, or universal serial bus (USB). One or more output devices 644 (e.g., display, a monitor, printer, projector, or other type of displaying device) is also connected to system bus 606 via interface 646, such as a video adapter.

Computer system 600 may operate in a networked environment using logical connections to one or more remote computers, such as remote computer 648. Remote computer 648 may be a workstation, computer system, router, peer device, or other common network node, and typically includes many or all the elements described relative to computer system 600. The logical connections, schematically indicated at 650, can include a local area network (LAN) and a wide area network (WAN). When used in a LAN networking environment, computer system 600 can be connected to the local network through a network interface or adapter 652. When used in a WAN networking environment, computer system 600 can include a modem, or can be connected to a communications server on the LAN. The modem, which may be internal or external, can be connected to system bus 606 via an appropriate port interface. In a networked environment, application programs 634 or program data 638 depicted relative to computer system 600, or portions thereof, may be stored in a remote memory storage device 654.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

### Additional Embodiments

The present disclosure is also directed to the following exemplary embodiments, which can be practiced in any combination thereof

Embodiment 1: A system, comprising: memory to store computer executable instructions; and one or more processors, operatively coupled to the memory, that execute the computer executable instructions to implement: a stochastic model configured to execute a Monte Carlo algorithm that quantifies uncertainty associated with parameters characterizing a geothermal subsurface reservoir via plurality of probability distributions; and an economic analyzer configured to estimate an amount of electrical energy associated with the geothermal subsurface reservoir based on the stochastic model.

Embodiment 2: The system of embodiment 1, wherein the economic analyzer is further configured to determine an amount of avoided carbon dioxide emissions based on an amount of hydrocarbon fuel associated with production of the amount of electrical energy and a carbon dioxide emission rate associated with the hydrocarbon fuel.

Embodiment 3: The system of embodiment 1 or 2, further comprising: an analytical mass and heat model configured to compute an amount of heat energy available from the subsurface reservoir based on the stochastic model, wherein the parameters are user defined inputs.

Embodiment 4: The system of any of embodiments 1-3, further comprising: a reservoir simulator configured to generate a computational model that characterizes the geological and geothermal properties of the subsurface reservoir and outputs one or more of the parameters.

Embodiment 5: The system of any of embodiments 1-4, further comprising: a reservoir simulator configured to generate a computational model that characterizes the geological and geothermal properties of the subsurface reservoir and outputs one or more of the parameters.

Embodiment 6: The system of any of embodiments 1-5, further comprising: an enhanced geothermal system operably coupled to the reservoir simulator and stochastic model, wherein the parameters include: a fluid outflow metric measured by a fluid gathering system of the enhanced geothermal system, and an electric power metric measured by an electrical conversion system of the enhanced geothermal system.

Embodiment 7: The system of any of embodiments 1-6, wherein the parameters further include a rare earth element concentration measured by a mineral gathering system of the enhanced geothermal system.

Embodiment 8: A computer-implemented method, comprising: executing a Monte Carlo algorithm that quantifies uncertainty associated with parameters characterizing a geothermal subsurface reservoir to generate a stochastic model of the parameters that includes a plurality of probability distributions; and estimating an amount of electrical energy associated with the geothermal subsurface reservoir based on the stochastic model.

Embodiment 9: The computer-implemented method of embodiment 8, further comprising: determining an amount of avoided carbon dioxide emissions based on an amount of hydrocarbon fuel associated with production of the amount of electrical energy and a carbon dioxide emission rate associated with the hydrocarbon fuel.

Embodiment 10: The computer-implemented method of any of embodiments 8-9, further comprising: computing, via an analytical mass and heat model, an amount of heat energy available from the subsurface reservoir based on the stochastic model, wherein the parameters are user defined inputs.

Embodiment 11: The computer-implemented method of any of embodiments 8-10, further comprising: generating, via a reservoir simulator, a computational model that characterizes the geological and geothermal properties of the subsurface reservoir and outputs one or more of the parameters.

Embodiment 12: The computer-implemented method of any of embodiments 8-11, further comprising: determining a fluid outflow metric that characterizes a volume, rate, or combination thereof of a fluid extracted from the geothermal subsurface reservoir; and estimating an amount of thermal energy associated with the geothermal subsurface reservoir, wherein the estimating the amount of electrical energy is based on the fluid outflow metric and the estimated amount of thermal energy.

Embodiment 13: The computer-implemented method of any of embodiments 8-12, further comprising: estimating an amount of a targeted mineral comprised within the geothermal subsurface reservoir.

Embodiment 14: The computer-implemented method of any of embodiments 8-13, wherein the target mineral is lithium oxide or a lithium carbonate equivalent.

Embodiment 15: A computer program product for predicting electrical energy production associated with a geothermal subsurface reservoir, the computer program product comprising a computer readable storage medium having computer executable instructions embodied therewith, the computer executable instructions executable by one or more processors to cause the one or more processors to: execute a Monte Carlo algorithm that quantifies uncertainty associated with parameters characterizing the geothermal subsurface reservoir to generate a stochastic model of the parameters that includes a plurality of probability distributions; and estimate an amount of electrical energy associated with the geothermal subsurface reservoir based on the stochastic model.

Embodiment 16: The computer program product of embodiment 15, wherein the computer executable instructions cause the one or more processors to: determine an amount of avoided carbon dioxide emissions based on an amount of hydrocarbon fuel associated with production of the amount of electrical energy and a carbon dioxide emission rate associated with the hydrocarbon fuel.

Embodiment 17: The computer program product of any of embodiments 15 or 16, wherein the computer executable instructions cause the one or more processors to: compute, via an analytical mass and heat model, an amount of heat energy available from the subsurface reservoir based on the stochastic model, wherein the parameters are user defined inputs.

Embodiment 18: The computer program product of any of embodiments 15-17, wherein the computer executable instructions cause the one or more processors to: generate, via a reservoir simulator, a computational model that characterizes the geological and geothermal properties of the subsurface reservoir and outputs one or more of the parameters.

Embodiment 19: The computer program product of any of embodiments 15-18, wherein the computer executable instructions cause the one or more processors to: determine a fluid outflow metric that characterizes a volume, rate, or combination thereof of a fluid extracted from the geothermal subsurface reservoir; and estimate an amount of thermal energy associated with the geothermal subsurface reservoir, wherein the estimating the amount of electrical energy is based on the fluid outflow metric and the estimated amount of thermal energy.

Embodiment 20: The computer program product of any of embodiments 15-19, wherein the computer executable instructions cause the one or more processors to: estimate an amount of a targeted mineral comprised within the geothermal subsurface reservoir.

The invention claimed is:

1. A system, comprising:
memory to store computer executable instructions; and
one or more processors, operatively coupled to the memory, that execute the computer executable instructions to implement:
a stochastic model configured to execute a Monte Carlo algorithm that quantifies uncertainty associated with parameters characterizing a geothermal subsurface reservoir via a plurality of probability distributions; and
an economic analyzer configured to estimate an amount of electrical energy associated with the geothermal subsurface reservoir based on the stochastic model.

2. The system of claim 1, wherein the economic analyzer is further configured to determine an amount of avoided carbon dioxide emissions based on an amount of hydrocarbon fuel associated with production of the amount of electrical energy and a carbon dioxide emission rate associated with the hydrocarbon fuel.

3. The system of claim 1, further comprising:
an analytical mass and heat model configured to compute an amount of heat energy available from the subsurface reservoir based on the stochastic model, wherein the parameters are user defined inputs.

4. The system of claim 1, further comprising:
a reservoir simulator configured to generate a computational model that characterizes the geological and geothermal properties of the subsurface reservoir and outputs one or more of the parameters.

5. The system of claim 4, further comprising:
an enhanced geothermal system operably coupled to the reservoir simulator and stochastic model, wherein the parameters include: a fluid outflow metric measured by a fluid gathering system of the enhanced geothermal system, and an electric power metric measured by an electrical conversion system of the enhanced geothermal system.

6. The system of claim 5, wherein the parameters further include a rare earth element concentration measured by a mineral gathering system of the enhanced geothermal system.

7. The system of claim 6, wherein the economic analyzer is further configured to predict an amount of rare earth elements contained within the geothermal subsurface reservoir based on the rare earth element concentration.

8. A computer-implemented method, comprising:
executing a Monte Carlo algorithm that quantifies uncertainty associated with parameters characterizing a geothermal subsurface reservoir to generate a stochastic model of the parameters that includes a plurality of probability distributions; and
estimating an amount of electrical energy associated with the geothermal subsurface reservoir based on the stochastic model.

9. The computer-implemented method of claim 8, further comprising:
determining an amount of avoided carbon dioxide emissions based on an amount of hydrocarbon fuel associated with production of the amount of electrical energy and a carbon dioxide emission rate associated with the hydrocarbon fuel.

10. The computer-implemented method of claim 8, further comprising:
computing, via an analytical mass and heat model, an amount of heat energy available from the subsurface reservoir based on the stochastic model, wherein the parameters are user defined inputs.

11. The computer-implemented method of claim 8, further comprising:
generating, via a reservoir simulator, a computational model that characterizes the geological and geothermal properties of the subsurface reservoir and outputs one or more of the parameters.

12. The computer-implemented method of claim 8, further comprising:
determining a fluid outflow metric that characterizes a volume, rate, or combination thereof of a fluid extracted from the geothermal subsurface reservoir; and
estimating an amount of thermal energy associated with the geothermal subsurface reservoir, wherein the estimating the amount of electrical energy is based on the fluid outflow metric and the estimated amount of thermal energy.

13. The computer-implemented method of claim 8, further comprising:
estimating an amount of a targeted mineral comprised within the geothermal subsurface reservoir.

14. The computer-implemented method of claim 13, wherein the target mineral is lithium oxide or a lithium carbonate equivalent.

15. A computer program product for predicting electrical energy production associated with a geothermal subsurface reservoir, the computer program product comprising a computer readable storage medium having computer executable instructions embodied therewith, the computer executable instructions executable by one or more processors to cause the one or more processors to:
execute a Monte Carlo algorithm that quantifies uncertainty associated with parameters characterizing the geothermal subsurface reservoir to generate a stochastic model of the parameters that includes a plurality of probability distributions; and
estimate an amount of electrical energy associated with the geothermal subsurface reservoir based on the stochastic model.

16. The computer program product of claim 15, wherein the computer executable instructions cause the one or more processors to:
determine an amount of avoided carbon dioxide emissions based on an amount of hydrocarbon fuel associated with production of the amount of electrical energy and a carbon dioxide emission rate associated with the hydrocarbon fuel.

17. The computer program product of claim 15, wherein the computer executable instructions cause the one or more processors to:
compute, via an analytical mass and heat model, an amount of heat energy available from the subsurface reservoir based on the stochastic model, wherein the parameters are user defined inputs.

18. The computer program product of claim 15, wherein the computer executable instructions cause the one or more processors to:
generate, via a reservoir simulator, a computational model that characterizes the geological and geothermal properties of the subsurface reservoir and outputs one or more of the parameters.

19. The computer program product of claim 15, wherein the computer executable instructions cause the one or more processors to:
determine a fluid outflow metric that characterizes a volume, rate, or combination thereof of a fluid extracted from the geothermal subsurface reservoir; and
estimate an amount of thermal energy associated with the geothermal subsurface reservoir, wherein the estimating the amount of electrical energy is based on the fluid outflow metric and the estimated amount of thermal energy.

20. The computer program product of claim 19, wherein the computer executable instructions cause the one or more processors to:
estimate an amount of a targeted mineral comprised within the geothermal subsurface reservoir.
